(19) United States
(12) Patent Application Publication
(10) Pub. No.: US 2003/0029573 A1
(43) Pub. Date: Feb. 13, 2003

(54) Formation of tyre beads or the like

(76) Inventor: Robert Franke, Losser (NL)

Correspondence Address: DANN DORFMAN HERRELL & SKILLMAN, SUITE 720, 1601 MARKET STREET, PHILADELPHIA, PA, 19103-2307, US

(21) Appl. No.: 10/220,348

(22) PCT Filed: Feb. 27, 2001
(86) PCT No.: PCT/EP01/02892

(51) Int. Cl. B29D 30/48

(52) U.S. Cl. 156/422

(57) ABSTRACT

A former (1) on which elongate material, such as tyre bead wire, can be wound, comprising a plurality of grooved segments (20-23), each movable radially between inner and outer positions and which, when in their outer positions, together define the entire periphery of the former and provide at least one groove (30,31) in which the elongate material can be wound in a plurality of convolutions, the segments (20-23) being movable into their inner positions to facilitate the removal of the wound elongate material from the former, and moving means (5-13) for moving the movable segments between their inner and outer positions. The segments (20-23), when in their inner positions, overlap one another and, when in their outer positions, have little or no gaps therebetween so that the or each circumferential groove is continuous. The invention also relates to a former (1) having a gripping device and to a guide assembly (80) for guiding elongate material.

### TECHNICAL FIELD

This invention relates to a former on which elongate material, such as tyre bead wire, can be wound into a plurality of convolutions, the former being of the kind comprising a plurality of grooved segments, each movable radially between inner and outer positions and which, when in their outer positions, together define the entire periphery of the former and provide at least one groove in which the elongate material can be wound in a plurality of convolutions, the segments being movable into their inner positions to facilitate removal of the wound elongate material from the former, and moving means for moving the movable segments between their inner and outer positions. In particular, but not exclusively, the invention relates to a former for forming at least one tyre bead. The invention also relates to a former provided with a gripping device and to a guide assembly for guiding springy elongate material, in particular tyre bead wire, onto a rotatable former.

### BACKGROUND OF THE INVENTION

In order to form a tyre bead, tyre bead wire is wound in a plurality of turns in a circumferential groove defined by the former. Generally this is achieved by securing the leading end of the tyre bead wire in a gripping device of the former and rotating the former. If the tyre bead wire is a single wire, the tyre bead may typically consist of 70 or 80 convolutions of the tyre bead wire wound so that the tyre bead core has a desired cross-section, e.g. a hexagonal section. The tyre bead wire is wound tightly into the peripheral, shaped groove of the former and, in order to facilitate subsequent removal of the fully wound tyre bead, it is desirable for each of the segments constituting the peripheral surface of the former to be movable radially inwards. In a typical former for a tyre bead made from convolutions of a single tyre bead wire, each segment is required to move radially inwards at least 25 mm to enable the formed tyre bead to be removed from the collapsed former. It is also known to form weftless tyre beads in which a plurality of separate bead wires are held together by a rubber coating on the wires to form a wire bead “tape”. Weftless tyre beads generally consist of a relatively small number of convolutions of the wire bead “tape” wound on top of each other. Since formed weftless tyre beads have fewer convolutions and are not wound tightly into shaped former grooves, they are generally easier to remove from the former.

A known former of the kind referred to is described in U.S. Pat. No. 5,603,799 and has a plurality of circumferentially positioned grooved segments which are radially moved together by the moving means between their inner and outer positions. In their inner positions, these segments define a closed annular surface with the grooves of the segments defining endless annular grooves. However, in their outer positions, the segments are circumferentially spaced apart from each other and the grooves of the segments, in which the tyre bead wire is wound, are also circumferentially spaced apart from each other. Thus the segments, when in their outer positions, do not provide a continuous grooved support surface for the tyre bead formed thereon.

It is also known from U.S. Pat. No. 3,051,221 for a former to have fixed and movable segments. In particular this known former has two fixed adjacent segments which together extend over about 120° and three movable segments. A first one of these movable segments is positioned opposite the two fixed segments and is movable radially inwards and outwards. Between the first movable segment and each of the two fixed segments are positioned second and third movable segments. Each of these second and third movable segments is mounted for pivotal movement between inner and outer positions with its pivot axis positioned adjacent to its associated fixed segment. The former is collapsed by initially pivoting the second and third movable segments inwards and then moving the first movable segment radially inwards. In this way the former is collapsed to allow removal of a tyre bead core wound on the former. However, the former of U.S. Pat. No. 3,051,221 is formed from both fixed and movable segments and thus is not entirely suitable for the formation of any type of tyre bead, in particular tyre beads formed from wound convolutions of a single tyre bead wire. Furthermore, there are circumferential gaps between adjacent segments when the former is in its expanded condition. Finally, it is difficult to adapt the former to cater for different diameter tyre beads being wound on the former.

Another known apparatus for forming tyre bead cores has three axially separable annular former parts, one former part defining a bottom wall of a former groove and the two other former parts defining opposite walls of the former groove. During formation of a tyre bead core, the annular former parts are positioned to define the former groove. On completion of a wound tyre bead core, the former parts are axially separated from each other to allow the tyre bead core to be pushed off the apparatus. A particular disadvantage of this known type of apparatus is that it is relatively complicated and is only suitable, at least without substantial modification, for the creation of a single tyre bead core on the apparatus at any one time.

### SUMMARY OF THE INVENTION

An aim of one aspect of the present invention is to provide an improved former for forming at least one wound assembly of elongate material, preferably tyre bead wire, which former provides at least one substantially continuous annular groove or the like into which elongate material is wound during the formation of the at least one wound assembly. A preferred aim of the invention is to provide apparatus in which more than one wound assembly can be formed at any time. Another preferred aim is to provide a former suitable for winding tyre bead cores from convolutions of single tyre bead wire (although the invention is intended also to embrace formers for winding of weftless beads or the like).

An aim of another aspect of the present invention is to provide a former for winding elongate material having an improved gripping means.

According to one aspect of the present invention there is provided a former on which elongate material, such as tyre bead wire, can be wound into a plurality of convolutions, the former comprising a plurality of grooved segments, each movable radially between inner and outer positions and which, when in their outer positions, together define the entire periphery of the former and provide at least one groove in which the elongate material can be wound in a plurality of convolutions, the segments being movable into their inner positions to facilitate removal of the wound elongate material from the former, and moving means for moving the movable segments between their inner and outer positions, characterised in that the moving means includes control means for controlling the radial movement of each of said segments so that the segments, when in their inner positions, partly overlap one another, and, when in their outer positions, are arranged so that the at least one groove in which the elongate material is wound in a plurality of convolutions is at least substantially continuous.

Since the or each groove is substantially continuous, i.e. with no (or only very small) circumferential gaps between adjacent segments when the segments are in their outer positions, the former according to the invention provides continuous circumferential support for one or more wound assemblies, e.g. tyre bead cores, of elongate material. Since there are no circumferential gaps between adjacent circumferentially positioned segments, the elongate material, e.g. tyre bead wire, can be wound in perfectly circular turns. Since the turns are perfectly round or circular, the paying on wheel which pays the elongate material onto the former whilst the latter is rotated during a winding operation, will have little or no tendency to “bounce” and cause winding irregularities. After rotation of the former to complete a wound assembly, the former can be collapsed to enable the wound assemblies to be removed from the former by moving the movable former segments to their inner positions. Since the collapse of the former merely involves the controlled radial inward movement of the former segments, the segments may have more than one peripheral groove formed in them so that more than one assembly can be wound at axially spaced apart positions on the former when the movable former segments are in their outer positions.

Conveniently the former has four segments, two of which provide a first pair of diametrically opposed segments and the other two of which provide a second pair of diametrically opposed segments. Preferably the control means move the segments of each pair inwardly and outwardly together between their inner and outer positions. In this case, the segments of one pair (the first pair) will need to be moved inwardly from their outer positions only after the segment of the other pair (the second pair) have been moved inwardly at least a certain amount from their outer positions. From the collapsed condition of the former, the segments of the first pair will have to be moved radially outwardly first before the segments of the second pair are moved radially outwardly. Preferably each segment of the second pair subtends a smaller angle than each segment of the first pair and circumferential outer portions of the segments of the first pair are arranged to partially overlap circumferential outer portions of the segments of the second pair when the segments are in their inner positions.

Preferably the control means comprises cam means for controlling the inward and outward movement of each segment. Typically, the cam means comprises a turnable first cam member having separate first camming means for each movable segment, and a separate radially movable second cam member associated with each movable segment and having second camming means, the first and second camming means cooperating with each other to control the inward and outward movement of the second cam members on turning of the first cam member in opposite directions. Suitably each second cam member is slidably guided by radially arranged guide means. Conveniently one of each cooperating pair of first and second camming means comprises a cam slot and the other of each cooperating pair of first and second camming means comprises a cam pin, each cam pin travelling along its associated cam slot on turning of the first cam member.

Although the control means preferably comprises cam means, other control means can be employed. For example, each segment can be moved inwardly and outwardly at the desired time by piston means. Alternatively, a system of connecting rods may be employed to control the movements of the segments.

Preferably each segment has at least two axially spaced apart circumferentially extending grooves, the grooves of the segments, when the latter are in their outer positions, defining at least two axially spaced apart endless circumferential grooves in which at least two wound assemblies, e.g. tyre bead wires, can be formed.

According to another aspect of the present invention there is provided a former on which elongate material, e.g. tyre bead wire, can be wound including gripping means comprising a first member and a second member movable inwardly and outwardly relative to the first member and with respect to a winding axis of the former, the first member having cavity means for receiving a free end portion of elongate material to be gripped and the second member having resilient pressing means, e.g. blade means, for resiliently contacting and pressing against wall means of said cavity means a free end portion of the elongate material received in said cavity means when the second member is in its outer position.

Preferably the first and second members are separate, circumferentially adjacent first and second segments of the former movable radially relative to one another. In this case, the cavity means conveniently comprises an opening or slot formed in, and opening into, an inner surface of the first segment and the pressing means, e.g. blade means, extends circumferentially from the second segment and is arranged so as to enter the opening or slot during outward movement, e.g. radial outward movement, of the second segment relative to the first segment for clamping against a “bottom” wall of the opening or slot an end portion of elongate material received in the opening or slot.

Preferably the pressing means, e.g. blade means, comprises relatively stiff spring metal, e.g. of steel or the like. Alternatively, however, the pressing means, e.g. blade means, may be provided with separate spring means for resiliently urging the pressing means, e.g. blade means, into contact with an end portion of elongate material to be clamped.

According to a further aspect of the present invention, there is provided a guide assembly for guiding springy elongate material, such as tyre bead wire, onto a rotatable former, comprising at least one channel-shaped guide with spaced apart side walls and a bottom wall and having an outlet end portion in which the side walls are relatively closely spaced apart from each other and an inlet end portion, feed means for feeding the elongate material into the inlet of the or each channel-shaped guide, and a rotatable wheel associated with the or each guide at the outlet end portion of the guide, wherein the inlet end portion of the or each guide is constructed and arranged to have greater rigidity than said outlet end portion perpendicular to an axial plane of the guide which is arranged between the side walls of the guide and which passes through the bottom wall of the guide.

### BRIEF DESCRIPTION OF THE DRAWINGS

Embodiment of the invention will now be described, by way of example only, with particular reference to the accompanying drawings, in which:

FIG. 1 is a schematic side view of on embodiment of a former according to the invention for manufacturing at least one tyre bead;

FIG. 2 is a view of the former shown in FIG. 1 but with its former segments removed;

FIG. 3 is a view of the incompletely formed former shown in FIG. 2 but with segment mounting means removed;

FIG. 4 is a view of the incompletely formed former shown in FIG. 3 but with slide means removed;

FIG. 5 is a schematic side view of an alternative former according to the present invention;

FIGS. 6 to 8 are perspective views, on enlarged scales, of a gripper mechanism of the former shown in FIG. 1 as viewed from below and to one side, from above and to one side and from above, respectively;

FIG. 9 is a schematic view illustrating an alternative form of gripper mechanism; and

FIGS. 10 - 12 are different schematic views of guiding means for guiding tyre bead wire into axially spaced apart circumferential grooves of the former shown in FIG. 1.

### DESCRIPTION OF THE PREFERRED EMBODIMENTS

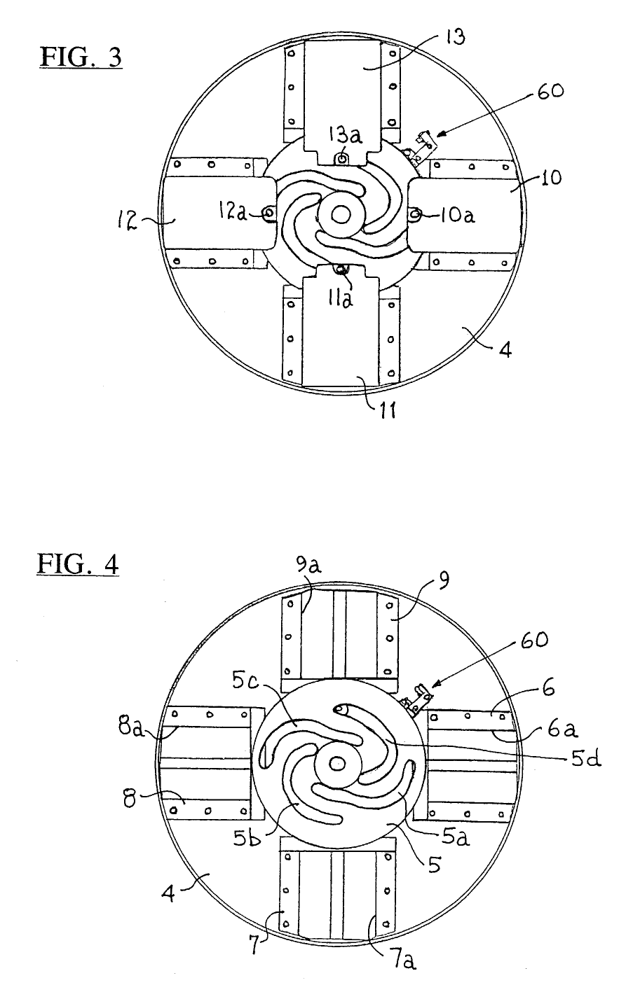

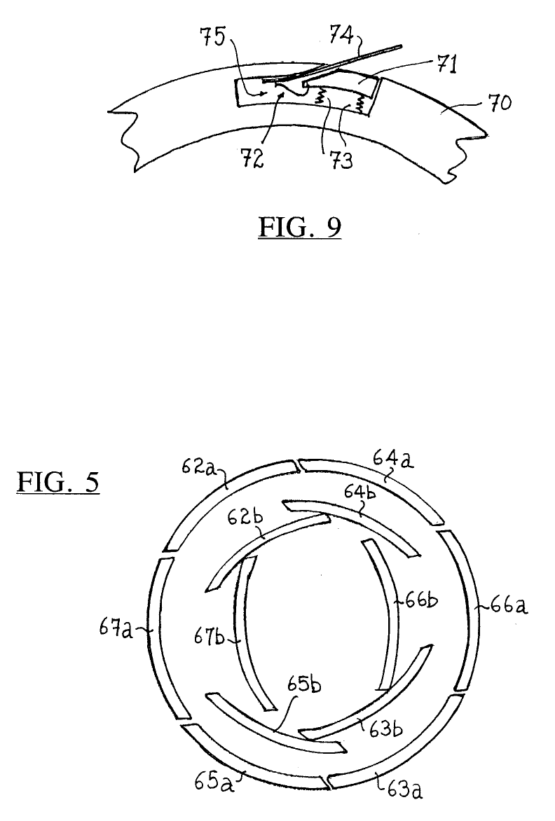

FIGS. 1 to 4 illustrate one embodiment of a former, generally designated by the reference numeral 1, for manufacturing a tyre bead wound from tyre bead wire and having a plurality of convolutions, e.g. up to 70 or 80 convolutions.

The former 1 is mounted for rotation about a turning axis 2. The leading end of tyre bead wire is intended to be gripped at a gripper mechanism 3 (described in more detail hereinafter) and the former is then rotated to wind the bead wire into at least one groove formed in the periphery of the former 1. Conventional means (not shown) are provided for rotating the former 1. In most applications, at the start and finish of a bead wire winding operation, the gripper mechanism 3 will be located at the top of the former. However, in FIGS. 1 to 4, the former 1 is shown in a position turned from its start/finish position with the gripper mechanism 3 offset from the vertical position. During the bead winding operation, the bead wire is guided onto the former by guiding means 80 described in more detail hereinafter with reference to FIGS. 10 - 12.

The former 1 shown in FIGS. 1 to 4 has a circular frame 4 mounted for turning about the axis 2 and carrying a circular cam disc 5 turnable relative to the frame about the axis 2. The frame carries four fixed guide members 6-9 bolted to the frame 4 and provided with four radially disposed guide channels 6a-9a, respectively, angularly spaced apart 90° from each other. Thus channels 6a and 8a (and 7a and 9a) are diametrically aligned with each other. The cam disc 5 (described in more detail later) has four cam slots 5a - 5d formed therein.

The side walls of the channels 6a-9a suitably have elongate slots (not shown) for slidably receiving side flanges (not shown) of guide plates 10-13 (see FIG. 3), respectively, so that the guide plates are received in, and are slidable along, the channels 6a-9a. Each guide plate 10-13 has a pin 10a - 13a respectively, at its radially inner end and projecting from its rear side (i.e. into the paper in FIG. 3). These pins 10a-13a are received in the cam slots 5a-5d, respectively.

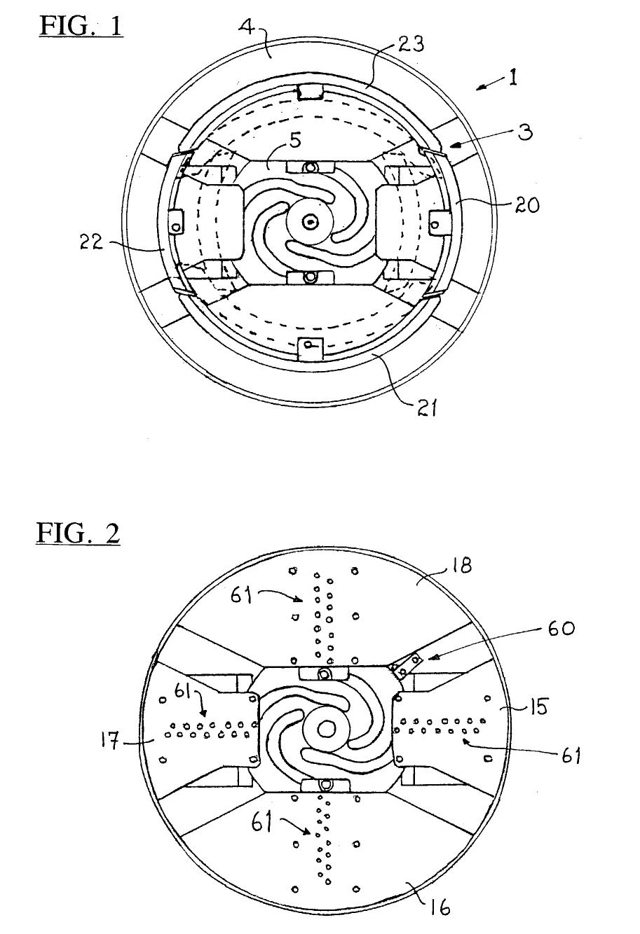

The guide plates 10-13 are fixed, e.g. bolted, to the rear side of segment mounting plates 15-18 (see FIG. 2), respectively. The mounting plates 15-18 carry segments 20-23 (see FIG. 1), respectively.

In FIG. 1 the segments are shown in full lines in their outer positions. However, on turning the cam disc 5 in the counterclockwise direction (as viewed in FIGS. 1 to 4) relative to the frame 4 through approximately 120°, the segments are moved radially inwardly to occupy inner positions (as shown in dashed lines in FIG. 1). As the cam disc is turned from its initial position shown in FIGS. 1-4, the cam pins 10a-10d move along the cam slots 5a-5d, respectively, moving the guide plates 10-13 radially inwardly along the guide channels 6a-9a. The cam slots 5a-5d are so shaped that during the initial turning of the cam disc 5 the segment mounting plates 15 and 17 are moved radially inwards towards each other whilst the segment mounting plates 16 and 18 remain stationary. Once the segments 20 and 22 have been moved radially inwardly of the segments 21 and 23, segment mounting plates 16 and 18 can be moved radially inwards. Thus continued turning of the cam disc 5 in the counterclockwise direction will cause the segment mounting plates 15 and 17 to be moved into their inner positions and the segment mounting plates 16 and 18 will commence their movement radially inwards moving the segments 21 and 23 radially inwards also. In the final stage of the counterclockwise turning of the cam disc 5, the segment mounting plates 16 and 18 and the segments 21 and 23 are moved into their radially innermost positions in which outer circumferential portions of the segments 21 and 23 overlap outer circumferential portions of the segments 20 and 22. The former is then in its fully collapsed position. Expansion of the former is achieved by turning the cam disc 5 back in the clockwise direction to its original position shown in FIGS. 1 to 4. The radially movable segment mounting plates 15-18 are moved outwardly in a controlled manner so that firstly the segments 21 and 23 and finally the segments 20 and 22 are moved together into their outer positions. It will be appreciated that the segment mounting plates 15-18 are suitably shaped to enable them to move into and out of their inner positions without interfering with one another.

Each of the segments 20-23 has two axially spaced apart grooves 30 and 31 (see FIGS. 7 and B) formed in its outer surface. When the segments are in their outer positions (i.e. the position shown in FIG. 1 in which the former is fully expanded), these grooves form two continuous annular grooves with no, or at least substantially no, spaces formed in the grooves between adjacent segments. Only one groove, or more than two grooves, may be provided depending on how many tyre beads are to be formed during a tyre bead winding procedure.

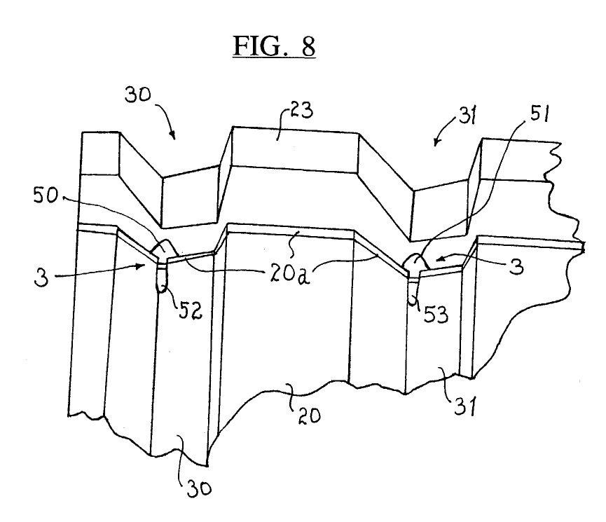

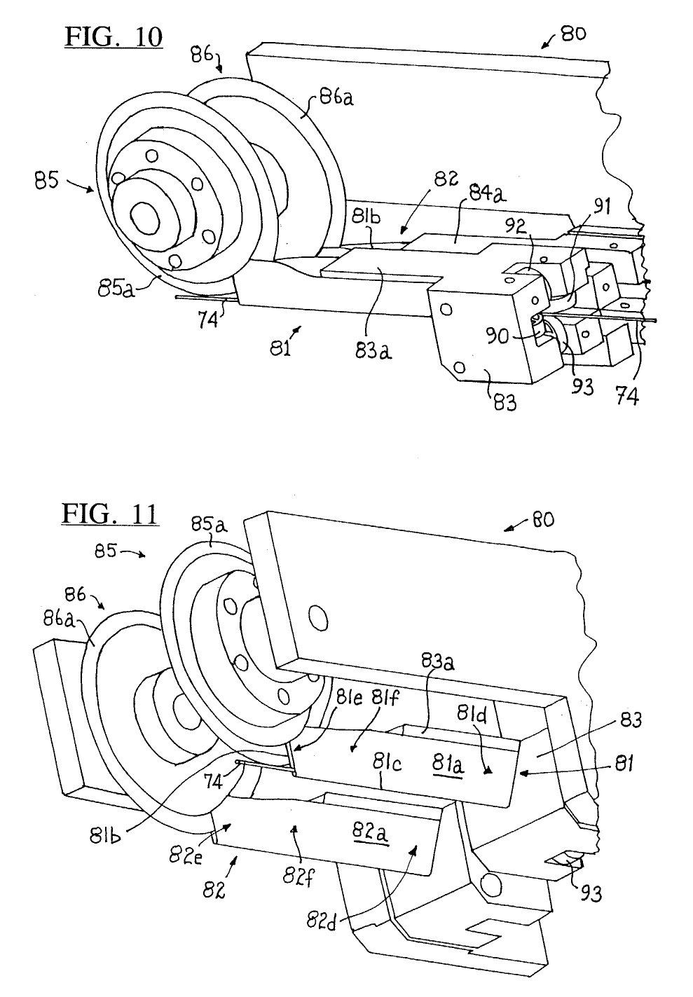

It will be appreciated that the confronting end faces of adjacent segments need to be formed so that the adjacent segments can move radially relative to each other without the segments interfering with each other. Furthermore the segments 20 and 22 have pieces 20a (see FIGS. 6-8) of hardened steel at their end faces.

Sets of segments with different curvatures can be mounted on the segment mounting plates 15-18 to enable differently sized formers to be provided. Accordingly the segment mounting plates may be provided with different mounting holes 61 (see FIG. 2) for the various differently sized formers that are catered for.

Although it is preferred to control the movements of the segments in the manner described, various modifications can be made. For example the cam disc 5 could be provided with cam pins movable in cam slots formed in the radially movable guide plates. Alternatively completely different guide/control means could be provided. For instance, a system of connection rods could be provided. Alternatively, piston means could be provided for controllably moving the segments separately as required.

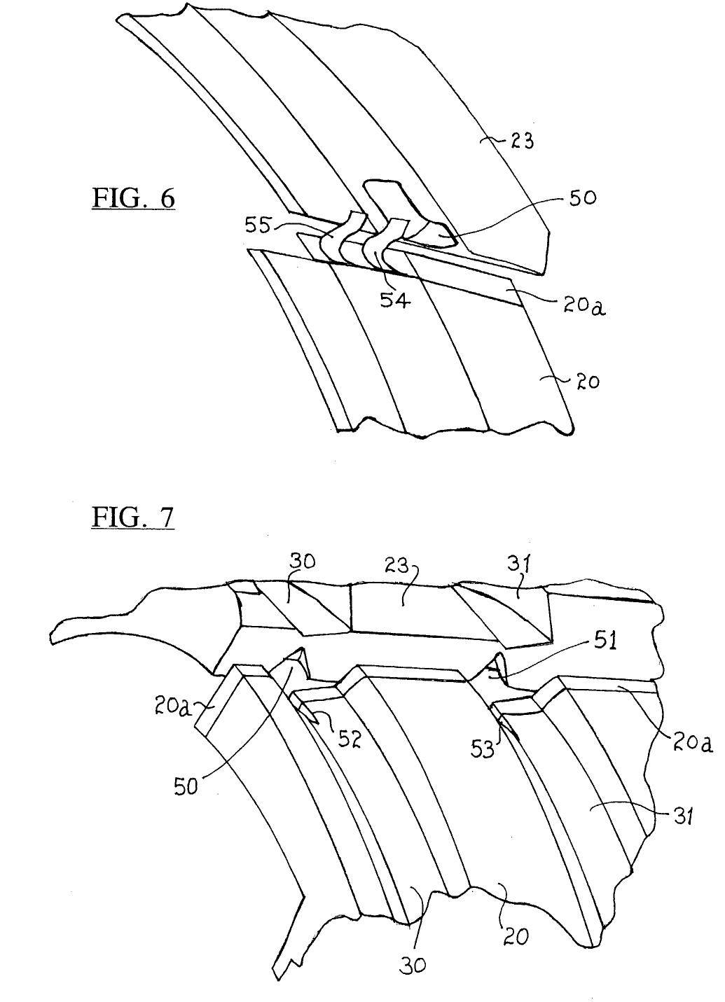

The arrangement of four segments 20-23 provides a particularly suitable design. However more than four segments can be provided. FIG. 5 shows, schematically how a 6-segment former 40 could be designed having three pairs of segments 62,63; 64,65; and 66;67 which overlap each other in their inner positions. In FIG. 5, the segments are designated with the letter “a” in their outer positions and designated with the letter “b” in their inner positions.

The former 1 (or any other type of former) is provided with a gripper mechanism. In particular, as depicted in FIGS. 6-8, the segment 23 is provided at its circumferentially outer edge which is adjacent segment 20 with V-shaped openings 50 and 51 beneath the grooves 30 and 31, respectively. The V-shaped openings open into the underside of segment 23 and, as shown in FIGS. 6-8, are inverted. The circumferentially outer edge of the segment 20 which is positioned adjacent the segment 23 has tapered grooves 52 and 53 in the bottom surface of the grooves 30 and 31, respectively, and also has two shaped blades 54 and 55 of spring metal, e.g. spring steel, which project circumferentially from a radially inner part of the segment 20.

In order to clamp an end portion of one or more tyre bead wires in the former, the cam disc 5 is turned so that the segment 20 is positioned radially inwardly of the segment 23, e.g. as shown in FIGS. 6-8. The wire end portion or portions is or are fed into the tapered groove or grooves 52 and 53 and positioned in the V-shaped slots 50 and 51. The cam disc 5 is then turned in the clockwise direction so that the segment 20 is moved into its radially outer position. During this movement, the spring blades 54 and 55 move into the slots 50 and 51 and engage and push against the (or each) wire end portion received in the slot 50 or 51. The or each wire end portion is thus clamped between the converging walls of the V-groove by the spring blade or blades. This clamping provides a simple and efficient means for clamping a wire or wires in the former. The provision of the tapered grooves 52 and 53 ensures that the clamped wire end does not interfere with subsequently wound convolutions of tyre bead wire formed on the former. Although it is preferred for the blades to be angled (as shown) so that they press against a wire end portion at an acute angle, this is not essential.

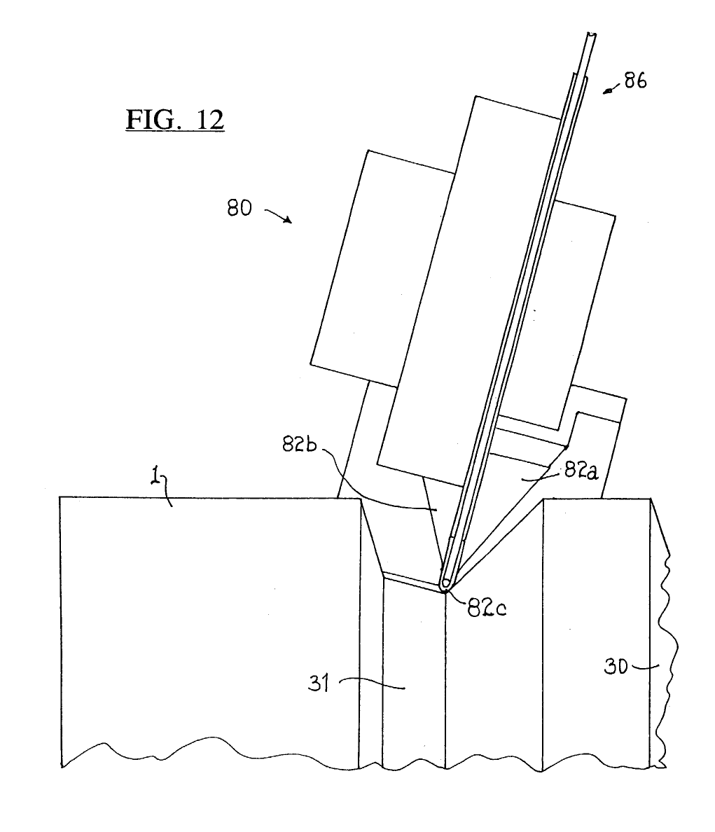

The gripper mechanism may of course be modified in other ways. The blades 54 and 55 may be of stiff material and may be urged by spring means (not shown). It is not essential for the gripper mechanism to constitute part of a former of the type shown in FIGS. 1 to 4. FIG. 9 shows schematically how a fixed segment 70 could be modified to incorporate a gripper mechanism according to the present invention. In the segment 70, there is a movable part 71 carrying a spring blade 72. Actuating means, shown schematically at 73, are provided to move the part 71 inwardly and outwardly. The end of a wire 74 or the like is received in a cavity 75 of the segment 70 when the part 71 is in its inner position. The part 71 is then moved outwardly so that spring blade 72 traps the wire end against a wall or walls of the cavity 75.

FIGS. 10 - 12 show guiding means 80 for feeding and guiding tyre bead wire 74 into the axially spaced apart circumferential grooves 30 and 31 of the former 1. For simplicity, only one tyre bead wire 74 is shown being fed and guided into the groove 30. However in practice two tyre bead wires would be fed into the two grooves 30 and 31. The purpose of the guiding means is to accurately guide bead wires into the circumferential former grooves, to step the bead wire across its associated groove after each turn during the formation of each row of bead wire turns and to prevent bead wire from unintentionally moving or jumping out of its associated groove.

The guiding means 80 is positioned at the top of the former and comprises two channel-shaped elongate metallic guides 81 and 82 carried by mounting parts 83 and 84 and having associated wheels 85 and 86, respectively. Each guide 81 (82) has spaced apart side walls 81a and 81b (82a and 82b) and a bottom wall 81c (82c) and is designed to have rigidity in transverse to its length, i.e. in the bead wire “stepping” direction in the direction between the side walls of the guide. Furthermore each guide has an upstream first end portion 81d (82d), a downstream second end portion 81e (82e) and an intermediate portion 81f (82f). For simplicity, only guide 81 will be described in detail although it will be appreciated that guide 82 is identical in form and construction to the guide 81.

The side walls 81a and 81b are angled downwardly towards the bottom wall 81c (i.e. they diverge in the direction away from the bottom wall) at the first end portion 81d but are at least substantially parallel to each other at the second end portion 81e, the change in the disposition of the side walls being accommodated in the intermediate portion 81f. Throughout the length of the guide, the side walls 81a and 81b are spaced apart a short distance in their lower portions where they meet the bottom wall 81c. In particular, this spacing apart is designed to be slightly greater than the diameter of the bead wire which is guided through the guide for winding on the former groove.

At the first end portion 81d, the top of the channel-shaped guide 81 is closed by a closure portion 83a of the mounting part 83. The closure portion extends towards the bottom wall 81c but is spaced therefrom to provide an opening defining the guide path for the bead wire 74. The closure portion 83a provides the guide 81 with rigidity along its length as does the triangular cross-section of the guide provided by its diverging side walls and the closure portion 83a. The second end portion 81e is narrow in the bead wire “stepping” direction (i.e. perpendicular to the substantially parallel side walls). If the elongate guide was this narrow throughout its length, it would be relatively weak, and be likely to bend, in the “stepping” direction on the application of a sideways force in the stepping direction to step the bead wire across the former groove into which it is being wound. However, in the design of the guide 81, the second end portion 81e is relatively short in length compared with the length of the first end portion 81d. The intermediate portion 81f is also relatively short in length compared with the first end portion 81d but it still has a changing, generally V-shaped cross-section along its length and is therefore relatively rigid.

The wheel 85 is mounted at or adjacent the second end portion 81e of the guide. In the embodiment shown, part of an outer circumferential portion 85a of the wheel 85 is received between the narrowly spaced apart substantially parallel side walls 81a and 81b. The part of the outer circumferential portion 85a received between the side walls 81a and 81b closes the top of the guide 81 at its second end portion 81e, defines with the bottom and side walls of the guide 81 an outlet for the bead wire. In addition to restraining or preventing sideways movement of the guide 81 in the stepping direction—i.e. parallel to the axis of the wheel 85—the wheel also guides the bead wire into the groove and prevents the bead wire from jumping or slipping out of the groove.

As mentioned previously, the bead wire has to be stepped across the former groove as the turns of each layer or row are formed. To prevent the wire being scraped against the side walls of the guide 81 as the guiding means is moved across in the stepping direction, inlet guide means are provided at the inlet to each guide. Thus the inlet to the guide 81 (and 82) has pairs of rolls 90, 91 and 92, 93 through which the wire 74 is fed. At the outlet end of the guide 81, the bead wire 74 is pressed by the wheel 85 into the circumferential groove 30. As can be seen in FIG. 12, the common axis of rotation of the wheels 85 and 86 is disposed at an angle to the axis of rotation of the former 1. The rim of each of the wheels 85, 86 is recessed and defines with the curved bottom wall 81c, 82c a substantially circular cross-section gap corresponding substantially to the cross-section of the bead wire 74. The outer circumferential portion 85a is of smaller axial thickness than the portion of the wheel radially inwardly thereof. The axial thickness of the portion 85a corresponds substantially to, or is just slightly less than, the spacing apart of the walls 81a and 81b at the second end portion 81e.

In use, the relatively but relatively short length narrow second end portion 81e, 82e of each guide 81, 82 is received within the groove 30, 31. As each convolution of tire bead wire 74 is wound on the former, the assembly of guides 81, 82 is moved or stepped across as required to the position of winding of the next convolution. Depending on the stepping direction, one or the other of the side walls of each guide, at the second end portion of the guide, will push the bead wire across its associated former groove in the stepping direction. In this way the desired bead cross-section is created. The wheels 85 and 86 turn about their common axis and guide the wires onto the former. The V-shaped section of each guide for much of its length provides the guide with rigidity in the transverse, stepping direction—i.e. perpendicular to an axial plane of the guide which is arranged between the side walls of the guide and which passes through the bottom wall of the guide. This is important because of the sideways forces that each guide has to resist when the bead wire is stepped across the former groove. Thus the bead wire is able to be accurately located in the former groove.

Although the guide assembly shown has two bead wire guides, it will be appreciated that one or more than two bead wire guides may be provided depending on the number of circumferential grooves formed in the former 1. The wheels 85, 86 are shown with part of their peripheries received between the guide side walls at the second end portion. However, it is envisaged that workable embodiments can be designed with each wheel spaced a short distance from its associated second end portion so as not to be received between the side walls of the guide.

1. A former (1) on which elongate material, such as tyre bead wire, can be wound into a plurality of convolutions, the former comprising a plurality of grooved segments (20-23), each movable radially between inner and outer positions and which, when in their outer positions, together define the entire periphery of the former and provide at least one groove (30,31) in which the elongate material can be wound in a plurality of convolutions, the segments being movable into their inner positions to facilitate removal of the wound elongate material from the former, and moving means (5-13) for moving the movable segments (20-23) between their inner and outer positions, characterised in that
the moving means includes control means (5) for controlling the radial movement of each of said segments (20-23) so that the segments, when in their inner positions, partly overlap one another, and, when in their outer positions, are arranged so that the at least one groove (30,31) in which the elongate material is wound in a plurality of convolutions is at least substantially continuous.

2. A former (1) on which elongate material, such as tyre bead wire, can be wound into a plurality of convolutions, the former comprising a plurality of grooved segments (20-23), each movable radially between inner and outer positions and which, when in their outer positions, together define the entire periphery of the former and provide at least one groove (30,31) in which the elongate material can be wound in a plurality of convolutions, the segments (20-23) being movable into their inner positions to facilitate removal of the wound elongate material from the former, and moving means (5-13) for moving the movable segments between their inner and outer positions, characterised in that
the moving means includes control means (5) for controlling the radial movement of each of said segments (20-23) so that the segments, when in their inner positions, are arranged with each circumferentially adjacent pair of segments partly overlapping one another, and, when in their outer positions, are arranged so that the at least one groove (30,31) in which the elongate material is wound in a plurality of convolutions is at least substantially continuous.

3. A former according to claim 1 or 2, characterised in that it has four segments, two of which provide a first pair (21,23) of diametrically opposed segments and the other two of which provide a second pair (20,22) of diametrically opposed segments.

4. A former according to claim 3, characterised in that the control means (5) move the segments of each pair inwardly and outwardly together between their inner and outer positions.

5. A former according to claim 3 or 4, characterised in that the control means is adapted to move the segments of the first pair (21,23) inwardly from their outer positions only after the segment of the second pair (20,22) have been moved inwardly at least a certain amount from their outer positions, and to move the segments of the first pair (21,23) radially outwardly from their inner positions before the segments of the second pair (20,22) are moved radially outwardly.

6. A former according to any one of claims 3 to 5, characterised in that each segment of the second pair (20,22) subtends a smaller angle than each segment of the first pair (21,23) and the segments of the first pair are arranged to partially overlap the segments of the second pair when the segments are in their inner positions.

7. A former according to any one of the preceding claims, characterised in that the control means 5 comprises cam means (5a-d,10a-d) for controlling the inward and outward movement of each segment.

8. A former according to claim 7, characterised in that the cam means comprises a turnable first cam member (5) having separate first camming means (5a-d) for each movable segment, and a separate radially movable second cam member (10-13) associated with each movable segment (20-23) and having second camming means (10a-13a), the first and second camming means cooperating with each other to control the inward and outward movement of the second cam members (10-13) on turning of the first cam member (5) in opposite directions.

9. A former according to claim 8, characterised in that each second cam member (10-13) is slidably guided by radially arranged guide means (6-9).

10. A former according to claim 9, characterised in that one of each cooperating pair of first and second camming means comprises a cam slot (5a-d) and the other of each cooperating pair of first and second camming means comprises a cam pin (10a-d), each cam pin travelling along its associated cam slot on turning of the first cam member (5).

11. A former according to any one of the preceding claims, characterised in that each segment (20-23) has at least two axially spaced apart circumferentially extending grooves (30,31), the grooves of the segments, when the latter are in their outer positions, defining at least two axially spaced apart endless circumferential grooves.

12. A former according to any one of the preceding claims, characterised in that the said segments include a first segment (20) and a second segment (23) movable inwardly and outwardly relative to the first segment (20) and with respect to a winding axis of the former, the first segment (20) having cavity means (50,51) for receiving a free end portion of elongate material to be gripped and the second segment (23) having resilient pressing means (54,55) for resiliently contacting and pressing against wall means of said cavity means a free end portion of the elongate material received in said cavity means (50,51) when the second segment is in its outer position.

13. A former according to claim 12, characterised in that said resilient pressing means (50,51) comprises blade means.

14. A former (1) on which elongate material, e.g. tyre bead wire, can be wound including gripping means comprising a first member (20) and a second member (23) movable inwardly and outwardly relative to the first member (20) and with respect to a winding axis of the former, the first member having cavity means (50,51) for receiving a free end portion of elongate material to be gripped and the second member (23) having resilient pressing means (54,55) for resiliently contacting and pressing against wall means of said cavity means a free end portion of the elongate material received in said cavity means (50,51) when the second member (23) is in its outer position.

15. A former according to claim 14, characterised in that said resilient pressing means (54,55) comprises blade means.

16. A former according to claim 14 or 15, characterised in that the first and second members (20,23) are separate, circumferentially adjacent first and second segments of the former movable radially relative to one another.

17. A former according to claim 13, or 15, characterised in that the cavity means comprises an opening or slot (50,51) formed in, and opening into, an inner surface of the first segment (20) and the blade means (54,55) extends circumferentially from the second segment and is arranged so as to enter the opening or slot (50,51) during outward movement, e.g. radial outward movement, of the second segment (23) relative to the first segment (20) for clamping against a “bottom” wall of the opening or slot an end portion of elongate material received in the opening or slot.

18. A former according to any one of claims 12 to 17, characterised in that the pressing means (54,55) comprises relatively stiff spring metal, e.g. of steel or the like.

19. A former according to any one of claims 12 to 18, characterised in that the pressing means is provided with separate spring means (73) for resiliently urging the pressing means (72) into contact with an end portion of elongate material (74) to be clamped.

20. A guide assembly (80) for guiding springy elongate material, such as tyre bead wire, onto a rotatable former, comprising at least one channel-shaped guide (81,82) with spaced apart side walls (81a-b,82a-b) and a bottom wall (81c,82c) and having an outlet end portion (81e,82e) in which the side walls are relatively closely spaced apart from each other and an inlet end portion (81d,82d), feed means (90-91,92-93) for feeding the elongate material into the inlet of the or each channel-shaped guide, and a rotatable wheel (85,86) associated with the or each guide (81,82) at the outlet end portion of the guide, wherein the inlet end portion (81d,82d) of the or each guide is constructed and arranged to have greater rigidity than said outlet end portion (81e,82e) perpendicular to an axial plane of the guide which is arranged between the side walls of the guide and which passes through the bottom wall (81c,82c) of the guide.

21. A guide assembly according to claim 20, characterised in that the side walls (81a-b,82a-b) of the or each guide (81,82) at said outlet end portion (81e,82e) are substantially parallel to each other.

22. A guide assembly according to claim 20 or 21, characterised in that the side walls (81a-b,82a-b) of the or each guide (81,82) at said inlet end portion (81d,82d) converge inwardly towards the bottom wall (81c,82c) of the guide.

23. A guide assembly according to any one of claims 20 to 22, characterised in that a top closure (83a,84a) is provided for closing the top of the or each guide (81,82) at its inlet end portion (81d,82d).

24. A guide assembly according to any one of claims 20 to 23, characterised in that the or each of said wheels (85,86) has an outer circumferential portion (85a,86a), the wheel being arranged so that, at any angular position of the wheel, a part of said outer circumferential portion is positioned between the side walls (81a-b,82a-b) of the guide so as to be spaced from the bottom wall (81c,82c) thereof and to define therewith an outlet for the springy elongate material from the guide.

25. A guide assembly according to any one of claims 20 to 23, characterised in that the or each of said wheels (85,86) is spaced from the outlet end portion (81e,82e) of the, or the associated, said guide.
